(19) United States
(12) Patent Application Publication
(10) Pub. No.: US 2023/0127746 A1
(43) Pub. Date: Apr. 27, 2023

(54) FOUNDATION PROFILE FOR AN OFFSHORE STRUCTURE

(71) Applicant: Daniel Bartminn, Elmshorn (DE)

(72) Inventor: Daniel Bartminn, Elmshorn (DE)

(73) Assignee: RWE Renewables GmbH, Essen (DE)

(21) Appl. No.: 18/087,135

(22) Filed: Dec. 22, 2022

Related U.S. Application Data
(63) Continuation of application No. PCT/EP2021/063861, filed on May 25, 2021.

(30) Foreign Application Priority Data
Jun. 23, 2020 (DE) 10 2020 116 518.8

(51) Int. Cl. E02B 17/00; E02D 5/62; E02D 27/52; E02D 27/42

(52) U.S. Cl. CPC E02B 17/0008; E02D 5/62; E02D 27/525; E02D 27/425; E02D 2300/0018; E02D 2600/30; E02B 2017/0091

(57) ABSTRACT

The present disclosure relates to a foundation profile for an offshore structure. The foundation profile includes a profile end portion, which is arranged in an offshore subsoil in the intended state of the foundation profile. Further, at least one elongated hollow body is arranged at the profile end portion in the intended state. The elongated hollow body is configured to receive a swellable material.

### CROSS-REFERENCE TO RELATED PATENT APPLICATIONS

This patent application is a continuation of International Application No. PCT/EP2021/063861, filed on May 25, 2021, which claims the benefit of priority to German Patent Application No. 10 2020 116 518.8, filed Jun. 23, 2020, the entire teachings and disclosures of both applications are incorporated herein by reference thereto.

### FIELD

The application relates to a foundation profile for an offshore structure, in particular, an offshore wind energy structure. Furthermore, the application relates to a foundation set, an offshore structure and a method for installing a foundation profile.

### BACKGROUND

Increasingly, offshore structures and offshore devices, respectively, are installed, in particular at sea. For example, offshore wind farms with a plurality of offshore wind energy devices are installed for electrical power generation and for providing electrical power, respectively, from so-called renewable energy sources. Offshore locations are usually characterized by relatively continuous wind conditions and high average wind speeds, so that so-called offshore wind farms are increasingly being built.

Typically, an offshore wind farm comprises a plurality of offshore wind energy devices, such as a plurality of offshore wind turbines, measuring masts, and/or at least one offshore substation. Via the offshore substation, the offshore wind farm may be electrically connected to, for example, an onshore substation or a further offshore substation and offshore converter station, respectively. An onshore substation, in turn, may be connected to a public power grid.

An offshore wind turbine is configured to convert the kinetic wind energy into electrical energy. Power cables in the form of submarine cables are installed to transfer the generated electrical energy between two offshore wind energy devices or an offshore wind energy device and an onshore device.

In comparison to onshore structures, installation and, in particular, anchoring in the offshore subsoil of an offshore structure is problematic and involves a great deal of effort.

For offshore wind farms, but also for other offshore structures, it is common to anchor an offshore structure directly on or in the offshore subsoil in the form of a water bottom, in particular, a seabed, by means of a foundation (e.g. monopile, tripod, tripile or jacket foundations).

A foundation comprises at least one foundation profile. A foundation profile comprises a profile end section, which is arranged in the offshore subsoil in an intended state of the foundation profile, i.e. in particular is inserted in the seabed.

In an installation process of the foundation profile, an inserting of the foundation profile, in particular, at least of the profile end section, into the offshore subsoil takes place, for example, by vibrating and/or ramming. In particular, when vibrating, but also when ramming, a reduction of soil compaction occurs in the area of the profile end section and thus a reduction of the internal friction angle at the contact surface between the profile end section and the offshore subsoil and consequently in a reduction of the tension in the soil.

In order to solve this problem, it is known from document DE 10 2017 121 037 A1 to provide the outer surface of the profile end section with a swellable material. The swellable material automatically begins to swell, i.e. to increase its volume, when it comes into contact with water, so that an increase in tension and thus an increase in a load-bearing capacity is achieved.

One disadvantage of the full-surface lining of the profile end section is that lateral and radial expansion of the swellable material occurs, which can lead to undesirable tensions at the foundation profile.

In addition, the expansion process in DE 10 2017 121 037 A1 cannot be controlled in terms of time. Rather, with the water-reactive swellable material used, the expansion process starts immediately upon contact with water. This can be problematic if the insertion of the profile end section into the offshore subsoil does not take place as intended, but if, for example, delays occur after the end section coated with the swellable material has already been immersed in the water, for example. Then the expansion of the swellable material may already be completed before the profile end section is finally inserted. This in turn means that the tension cannot be increased in the desired way, so that the load-bearing capacity is reduced and is not increased, respectively, as planned. In this case, additional measures for soil compaction must then be taken, which are associated with a high level of effort.

### BRIEF SUMMARY

Therefore, the object of the application is to provide a foundation profile for an offshore structure, which enables an increase of the tension at the contact surface between an offshore subsoil and a profile end section of the foundation profile in an improved and, in particular, more reliable manner.

The object is solved according to a first aspect of the application by a foundation profile for an offshore structure according to the present disclosure. The foundation profile comprises a profile end section arranged in an offshore subsoil in the intended state of the foundation profile. The foundation profile comprises at least one elongated hollow body arranged (and laid, respectively) on (and around, respectively) the profile end section in the intended state, configured to receive a swellable material.

In that, in contrast to the prior art, the swellable material is not applied over the entire surface on the outside of the profile end section, but an elongated hollow body is arranged on the profile end section, which is configured to receive and to fill, respectively, with a swellable material, an increase in the tension at the contact surface between the offshore subsoil and the profile end section of the foundation profile is made possible in an improved manner. In particular, according to the application, a wider range of swellable materials can be used, which can preferably have higher expansion rates than those usable in the prior art.

A precise laying of the elongated hollow body and thus a more precise expansion of the swellable material can take place. In addition, the laying of the elongated hollow body offers the possibility of controlling the expansion of a swellable material in terms of time. In particular, a filling of the at least one elongated hollow body can be timed to ensure that an expansion of the swellable material does not occur too early. The installation of a foundation profile can be performed with increased reliability. In this regard, the control in time can be achieved by a precise subsequent injection and/or by reaction-delaying properties of the elongated hollow body, its wall and/or bedding.

A foundation comprises at least one foundation profile according to the application or forms the foundation profile according to the application. A foundation, and thus the foundation profile according to the application, can in particular be a part of an offshore structure. In particular, a foundation profile serves to support an offshore device of the offshore structure.

An offshore device and offshore structure, respectively, is preferably an offshore wind energy device, such as an offshore wind turbine, an offshore measuring mast, or an offshore substation. Further, an offshore structure may be a drilling or production platform or other platform for extracting, converting, or storing energy, such as a hydrogen production facility.

As has been already described, an offshore structure may comprise an offshore unit, which may be fixed by the foundation profile according to the application in an offshore subsoil, preferably in the form of a water bottom, in particular, a seabed. An offshore structure may, in particular, be formed by the offshore unit (e.g., a platform, a nacelle, etc.) and the foundation.

Exemplary and non-exhaustive foundations and foundation structures, respectively, comprise monopile, tripod, tripile, or jacket foundations. Such a foundation may comprise at least one foundation profile, in particular in the form of a foundation pile.

According to the application, a foundation profile means, in particular, an elongated structural member, which may preferably have a substantially identical cross-section. A foundation profile may be a solid profile and closed profile, respectively (e.g., solid pile) or an open profile and hollow profile, respectively (e.g., hollow pile). A foundation profile may preferably be formed of metal, in particular, steel. However, other materials are also conceivable alternatively or additionally, such as concrete, glass fiber (glass fiber composite), carbon fiber (carbon fiber composite) and/or wood. In principle, the cross-sectional shape can be formed as desired, preferably substantially circular. In particular, the foundation profile can be formed in a cylindrical shape and tower shape, respectively.

A foundation profile according to the application comprises a profile end section. By the profile end section is meant, in particular, that part and section, respectively, of the foundation profile which, in an intended state and installed state, respectively, of the foundation profile, i.e. when the foundation profile has been installed with a desired (minimum) penetration depth in the offshore subsoil, is arranged in the offshore subsoil, i.e. lies substantially below the offshore subsoil surface. This section may also be referred to as the anchor section, as it serves to anchor the foundation profile in the offshore subsoil. The further part and section, respectively, of the foundation profile above the profile end section is in particular surrounded by water and serves in particular to support an (directly or indirectly) adjoining offshore unit.

According to the application, the foundation profile comprises at least one elongated hollow body arranged and laid, respectively, at the profile end section. In particular, this means that at least one elongated hollow body is arranged on and in, respectively, the outer wall of the profile end section. In one embodiment, the elongated hollow body may be laid externally to an outer wall of the profile end section, in particular be attached thereto. In a preferred embodiment, the elongated hollow body may be at least partially embedded and integrated, respectively, in an outer wall element of the profile end section.

In the present application, an elongated hollow body means, in particular, a hose. The elongated and in particular flexible hollow body may preferably be formed cylindrically and comprise a circumferential outer wall and sheathing, respectively. The sheathing may enclose an interior space.

Preferably, the elongate hollow body may be formed of a flexible material, such as a plastic material. In particular, the flexible material may allow the volume of the elongate hollow body to widen and expand, respectively.

The elongated hollow body is configured to receive a swellable material, i.e. to be filled therewith. In particular, the interior space described above is used for this purpose. By a swellable material is meant, in particular, a material which can expand its volume in combination with a further material. Preferably, the swellable material can be a water-reactive material which swells and expands, respectively, in combination with water, e.g. by sulfate driving.

It shall be understood that two or more elongated hollow bodies may be provided. It shall be further understood that at least a portion of the elongated hollow body may be disposed on the at least one further section of the foundation profile.

As has been described, the elongated hollow body may comprise a sheathing of a flexible material and stretchable material, respectively. Preferably, the material of the elongated hollow body may have a Young's modulus (also called modulus of elasticity) of at most 10 GPa (at 20° C.), for example between 0.01 and 5 GPa (at 20° C.). When such a hollow body (at least in a section of the elongated hollow body) is (almost completely) filled with a pre-described swellable material, an increase in the volume of the hollow body (at least in said body section) can be caused by the swellable material upon an expansion of the swellable material. The expansion rate of the swellable material may be 1%.

For example, the hollow body may have a diameter (in a normal state) between 2 and 10 cm. In an expanded state, the diameter may be increased between 0, 5 and 5%, for example between 1 and 2%.

According to a further embodiment of the foundation profile according to the application, the elongated hollow body may, alternatively or additionally, be a perforated elongated hollow body. In other words, the elongated hollow body may comprise, at least in sections, a plurality of (perforation-) openings and holes, respectively, in the sheathing. Advantageously, an opening may be formed in such a way that, upon expansion of the swellable material, the latter may partially penetrate through the openings to the outside. Alternatively or additionally, by the (perforation-) openings it can be achieved that water can (automatically) penetrate into the elongated hollow body, for example, during an installation process. In the case of a water-reactive material, it is achieved that the expansion of the swellable material is (automatically) caused and started, respectively.

The diameter of the openings can be selected in such a way that, in the case of an elongated hollow body pre-filled with a swellable material (i.e. filled before the installation process of the foundation profile), water can penetrate, but the swellable material in its initial state (i.e. before a swelling process and expansion process, respectively) can (almost) not reach the outside.

In principle, the elongated hollow body can be arranged in any way on the profile end section, i.e., in particular, it can be laid in any pattern on the profile end section. For example, a plurality of elongated hollow bodies may be arranged at the profile end section, in particular, running substantially parallel to the longitudinal axis of the foundation profile.

Also, an elongated hollow body may be arranged in a U-shape, wherein in particular the two legs of the U-shape may extend substantially parallel to each other and in particular to the longitudinal axis of the foundation profile.

According to a preferred embodiment of the foundation profile according to the application, the at least one elongated hollow body may be arranged and laid, respectively, in a spiral shape around the profile end section, preferably in a double spiral shape. The axis of the spiral shape may be substantially identical to the longitudinal axis of the foundation profile. Such a course increases the bracing at said contact surface in a particularly efficient manner.

As has already been described, the swelling material may preferably be a water-reactive material. According to a preferred embodiment of the foundation profile according to the application, the swelling material may be selected from the group comprising:
cement-based material,
CaO (calcium oxide) based material,
Al powder based material,
alkali silicon dioxide (alkali silica) (reactive) material mixtures, and
alkali carbonate (reactive) mixtures of materials.

Such materials have proven to be well suited for use in foundation profiles and, in particular, exhibit high expansion rates. Particularly preferably, a so-called swelling explosive (e.g. Dynacem®) can be used, which can, in particular, be based on CaO.

As has already been described, preferably the at least one elongated hollow body can be at least partially integrated in an outer wall element of the profile end section—irrespective of the installation pattern. According to a preferred embodiment of the foundation profile according to the application, the elongated hollow body may be at least partially embedded in an outer wall element of the profile end section. For example, the sheathing may be fully integrated and enclosed, respectively, within the outer wall element. Alternatively, at least a portion of the sheathing may extend outwardly from the outer wall element. In particular, the hollow body may be press-fitted within the outer wall element.

The outer wall element may be at least partially made of a concrete-containing material and/or a mortar-containing material. In particular, the at least one elongated hollow body may be integrated in one or more outer wall element(s) formed of mortar, grout, or a concrete cylindrical shell. Preferably, the outer wall element may comprise a reinforcement that is mechanically connected, for example, to a (circumferential) profile base body.

Alternatively or preferably additionally, the profile end section may comprise at least one profile base body with at least one outwardly directed (circumferential) recess. In particular, the profile base body may be made of metal (e.g., steel) and/or a glass fiber composite material and/or a carbon fiber composite material.

The profile end section may comprise at least one outer wall element inserted in the recess. As has been described, preferably at least one elongated hollow body may be embedded in said outer element.

According to a further embodiment of the foundation profile, the elongated hollow body may comprise at least one filling opening configured to fill (in particular inject) at least the swellable material into the elongated hollow body. Preferably, the at least one filling opening may be arranged at at least one end of the elongate hollow body. Conceivably, the other end of the elongate hollow body is closed, i.e., in particular, there is no filling opening at the other end. It shall be understood that the hollow body may, however, be perforated at the other end, as previously described. Further, in other variants, two (or more) filling openings may be provided. For example, in the previously described U-shaped configuration of an elongated hollow body, a filling opening may be provided at each end.

A filling opening differs from a pre-described (perforation) opening in particular in the diameter. Thus, the diameter of the filling opening may be at least twice as large, preferably at least five times as large (preferably between ten and twenty times as large), as the diameter of a perforation opening. In variants of the application, the filling opening may be formed to be closable.

In the intended state of the foundation profile, the filling opening may be located at least above the offshore subsoil surface. In other words, the at least one filling opening may be arranged at the section provided above the profile end section.

The at least one filling opening, in particular, a filling opening located above the offshore subsoil surface at least in the installation state, allows the expansion of the swellable material to be controlled in time. For example, the swellable material can be filled only at the installation site, for example during and/or after the installation process of the foundation profile. Alternatively or additionally, the hollow body may be pre-filled and water may only be filled in at the installation site, for example during and/or after the installation process of the foundation profile.

Particularly preferably, according to the application, the at least one elongated hollow body can be filled with a (locally) produced mixture of swellable material and water. In addition to an optimal mixing ratio and thus an optimized swelling process, the swelling process can thereby be controlled in terms of time. In particular, the controlling in terms of time can take into account time delays in the insertion process.

For example, a watercraft, in particular a ship, with an injection device (for example, a shotcrete machine) can be provided at the installation site of the foundation profile. The injection device may be temporarily couplable to the at least one filling opening via a connecting hose. In particular, the injection device may be configured to inject at least the swellable material (and/or water) into the hollow body, for example, with a specific mixing ratio of swellable material to water. In particular, a pressure application may be performed to allow (nearly complete) filling of the hollow body with the swellable material or, preferably, said mixture.

The mixture, in particular, containing cement, may be designed such that the pressure development and the volumetric development of the mixture are adapted to the contained concrete, so that the yielding of the reinforcement is achieved at a time when the volumetric development is achieved at least 1 hour after the injection, preferably 3 hours after the injection.

A further aspect of the application is a foundation set. The foundation set comprises at least one foundation profile (in particular, according to the present disclosure (but without a fixed hollow body)) with at least one profile end section arranged in an offshore subsoil in the intended state of the foundation profile. The foundation set comprises at least one elongated hollow body arrangeable (and layable, respectively) on (and around, respectively) the profile end section in the intended state, configured to receive a swellable material.

A further aspect of the application is an (in particular, pre-described) offshore structure, in particular, an offshore wind energy structure. The offshore structure comprises at least one previously described foundation profile. For example, the offshore structure may comprise a foundation having at least one previously described foundation profile.

A still further aspect of the application is a method of installing a foundation profile comprising at least one profile end section and at least one elongated hollow body arranged (and laid, respectively) around the profile end section, in particular, a previously described foundation profile. The method comprises:
filling at least one swellable material into the elongated hollow body, and
inserting the profile end section of the foundation profile into an offshore subsoil.

The inserting of the profile end section of the foundation profile into the offshore subsoil may preferably comprise vibrating the profile end section of the foundation profile (to a predeterminable minimum penetration depth). Vibratory driving reduces, in particular, the impermeability of the offshore subsoil in the area of the profile end section.

Alternatively or additionally, ramming of the profile end section of the foundation profile may be performed. It shall be understood that other methods may also be used, such as making a hole and then inserting the foundation profile into this hole.

By filling in, the expansion can be controlled in time. The caused increased tension of the contact surface between the foundation profile and the offshore subsoil increases the skin friction, so that in turn the load-bearing capacity can be increased.

The filling of the at least one elongated hollow body with a swellable material can take place prior to the inserting of the profile end section of the foundation profile, for example, already onshore or in a harbor. For example, the filling may be done at the factory.

According to a preferred embodiment of the method according to the application, the filling of at least the swellable material may take place at an offshore installation site of the foundation profile, i.e., in particular (immediately) prior to the installation of the profile end section of the foundation profile into an offshore subsoil, during the installation and/or after the installation. This may facilitate installation and, in particular, transportation of the foundation profile to the installation site. A controlling in terms of timing of the swelling process can be achieved. As has been described, for example, a watercraft with an injection device can be used for the filling.

According to a further preferred embodiment of the method according to the application, the filling of the swellable material may comprise filling a mixture of the swellable material and at least one further material (preferably water) causing the expansion of the swellable material. In particular, the preparation of the mixture may be performed by mixing said materials (on site, i.e., in particular at the installation site) with a specific mixing ratio. Immediately after preparation of the mixture (or after a specific time delay), the mixture may be filled and injected, respectively, into the at least one elongated hollow body, as previously described.

According to a particularly preferred embodiment of the method according to the application, an at least partial filling of the elongated hollow body with an intermediate fluid, in particular in the form of a liquid, may be carried out. An intermediate fluid is, in particular, a liquid, preferably water, with which the elongated hollow body is filled prior to filling with the swellable material. This allows the elongated hollow body to retain its shape even if, for example, it is at least partially integrated in an outer wall element.

In particular, it can be achieved that no constrictions are formed in the hollow body. It has been recognized, for example, that in the case of a hollow body filled only with air (with perforation and/or filling opening(s)), it can happen that a force acting on the shell of the hollow body (for example from a material embedding the hollow body) can (permanently) reduce the volume and diameter, respectively, of the hollow body (down to a diameter of 0 cm). In this case, (complete) filling of the hollow body with a swellable material cannot take place or can only take place with increased effort. By the intermediate filling it is achieved that constrictions can be prevented and in particular a complete filling of the hollow body can be ensured.

In particular, according to an embodiment, it is proposed that the intermediate fluid is emptied from the hollow body (immediately) before filling the swellable material into the hollow body. Preferably, the intermediate fluid may be at least partially drained from the elongated hollow body at an offshore installation location of the foundation profile. For example, the intermediate fluid can be drained and/or pumped out through an opening (which can be closed and opened).

The features of the foundation profiles, foundation sets, offshore structures and methods can be freely combined with each other. In particular, features of the description and/or dependent claims can be independently inventive, even by completely or partially bypassing features of the independent claims, in sole position or freely combined with each other.

### BRIEF DESCRIPTION OF THE DRAWINGS

There is now a multitude of possibilities to design and further develop the foundation profile according to the application, the foundation set according to the application, the offshore structure according to the application and the method according to the application. For this purpose, reference is made on the one hand to the claims subordinate to the independent claims, and on the other hand to the description of embodiments in connection with the drawing. In the drawings:

FIG. 1 shows a schematic perspective view of an embodiment of a foundation profile according to the present application;

FIG. 2 shows a schematic (sectional) view of an embodiment of an offshore structure according to the present application with an embodiment of a foundation profile according to the present application;

FIG. 3 shows a schematic view of a further embodiment of a foundation profile according to the present application;

FIG. 4 shows a schematic view of a further embodiment of a foundation profile according to the present application;

FIG. 5 shows a schematic view of a further embodiment of a foundation profile according to the present application; and

FIG. 6 shows a diagram of an embodiment of a method according to the present application.

### DETAILED DESCRIPTION OF THE INVENTION

In the following, the same reference signs are used for the same elements. Furthermore, in the embodiments, X denotes the vertical direction and Y denotes a horizontal direction in the following.

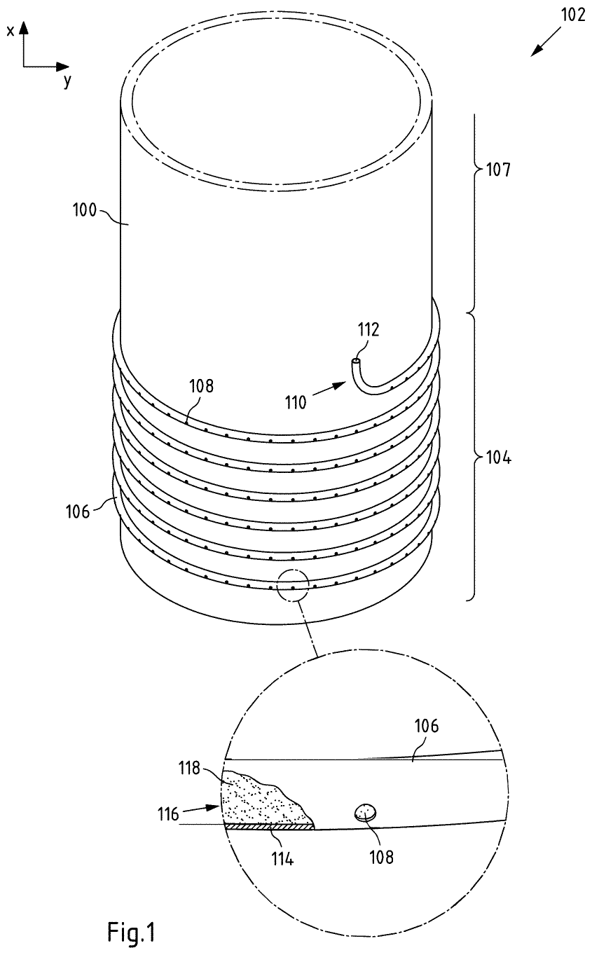

FIG. 1 shows a schematic perspective view of an embodiment of a foundation profile 100 for an offshore structure according to the present application. In particular, the foundation profile 100 is part of a foundation 102. In an exemplary foundation 102 in the form of a monopile 102, the foundation profile 100 may form the foundation 102. It shall be understood that in other variations, other foundations may be provided with, for example, a plurality of foundation profiles.

In the present embodiment, the foundation profile 100 is formed as a cylindrical pile 100, for example, a hollow or solid pile 100. The diameter of the foundation profile 100 may remain substantially constant. Preferably, the foundation profile 100 may be made of steel and/or a glass fiber composite and/or a carbon fiber composite.

As can be seen, the foundation profile 100 comprises a profile end portion 104. In particular, the profile end section 104 is the section 104 of the foundation profile 100 that is arranged in the offshore subsoil in an intended state of the foundation profile 100, i.e. when the foundation profile 100 is anchored in the offshore subsoil.

In particular, the profile end portion 104 may have a length of ⅓ of the total length of the foundation profile 100.

According to the application, an elongated hollow body 106 is arranged at least at the profile end section 104. The elongated hollow body 106 is, in particular, a hose 106. As can, in particular, be seen from the enlarged section of FIG. 1, the hose 106 comprises a sheathing 114 which encloses a cavity 116 and interior, respectively.

The cavity 116 may be at least partially, preferably completely, filled or at least fillable with a swellable material 118. In particular, this means that the hose 106 is configured to receive a swellable material 118 and to be filled with a swellable material 118, respectively.

Particularly preferably, the swellable material 118 may be a so-called swelling explosive 118 (e.g., Dynacem®), which may be based on CaO. As described above, other swellable materials may also be used. In particular, the swellable material 118 may be a water reactive material 118.

Preferably, the sheathing 114 may be formed of a flexible and/or elastic material. The elastic material, preferably a plastic material and/or a textile material, may, in particular, have a Young's modulus between 0.01 and 5 GPa (at 20° C.). Such a material in particular allows for an increase in volume of the hose 106, effected by an expansion of the swellable material 118.

Optionally, the hose 106 may be perforated and, in particular, may comprise openings 108 and perforations 108, respectively. The (perforation) openings 108 may allow water to enter the hollow body 106, in particular, during and/or after the inserting of the profile end portion 104 of the foundation profile 100 into the offshore subsoil. By the entering of water a chemical reaction between the swellable material 118 and the entered water is started, which leads to an expansion and, in particular, an increase in volume of the swellable material 118 arranged in the hose 106. This in turn leads to an increase in the volume of the hose and/or the swellable material 118 penetrates at least partially to the outside through the openings 108 (and thus increases the volume of the hose 106).

As has already been described, increasing the volume of the hose 106 can, in particular, increase the bracing between the profile end section 104 and the offshore subsoil. In a safe and at the same time simple manner, an anchoring of the foundation profile 100 in the offshore subsoil can be achieved.

In the present embodiment, the hose 106 comprises a filling opening 112 at one end 110 of the hose 106, wherein the filling opening 112 is configured to fill and to be filled (in particular, inject) the hose 106 at least with the swellable material 118. Preferably, a mixture of swellable material 118 and water (in particular, in the case of a non-perforated hose) can be injected into the hose through the filling opening 112.

The filling opening 112 may be located at a section 107 of the foundation profile 100 that is above the profile end portion 104 in the vertical direction X. In other words, in an intended state of the foundation profile 100, the filling opening 112 is, in particular, arranged above the offshore subsoil surface. In particular, this allows a controlling in terms of times of the expansion process in that the filling of the at least one hose 106 (for example, with the described mixture) can be controlled in terms of time.

In other variants of the application, a plurality of filling openings or no filling opening may also be provided. It shall be further understood that in other variants of the application, a plurality of hoses may be provided.

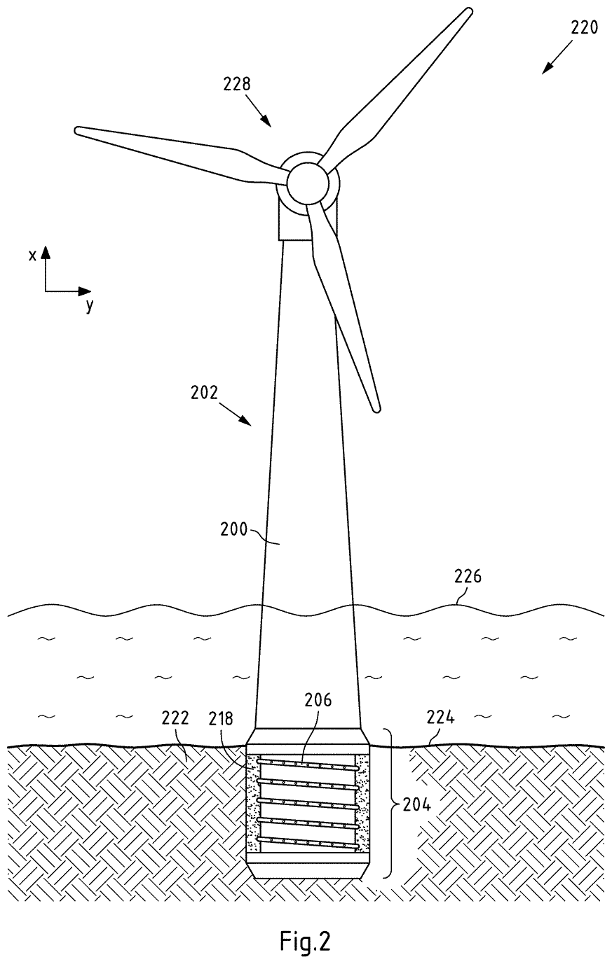

FIG. 2 shows a schematic view of an offshore structure 220 according to the present application with an embodiment of a foundation profile 200 according to the present application. In order to avoid repetitions, essentially only the differences from the previous embodiment are explained below and otherwise reference is made to the previous embodiments.

Exemplarily, the offshore structure 220 in the present application is an offshore wind turbine 220. In a known manner, an offshore wind turbine 220 comprises an offshore wind energy device 228 and a foundation 202. In the present case, the offshore structure 220 and thus the foundation 202, in the present case formed by the foundation profile 200, are shown in an installation state and anchoring state, respectively, of the foundation profile 200.

As can be seen from FIG. 2, the profile end section 204 is arranged, in particular anchored, in the offshore subsoil 222 in the installation state. Reference sign 224 denotes the offshore subsoil surface and reference sign 226 denotes the water surface, in particular, the sea surface.

As can be seen moreover, in the intended state, at least one elongated hollow body 206 is laid and arranged, respectively, at and around, respectively, the profile end section 204, the elongated hollow body 206 being configured to receive a swellable material 218.

In the present embodiment, the at least one elongated hollow body 206 is laid in a spiral shape around the profile end section 204, preferably in a double spiral shape. The axis of the spiral may be substantially identical to the longitudinal axis of the foundation profile 200. Such a course of the hollow body increases the bracing at the contact surface in a particularly efficient manner.

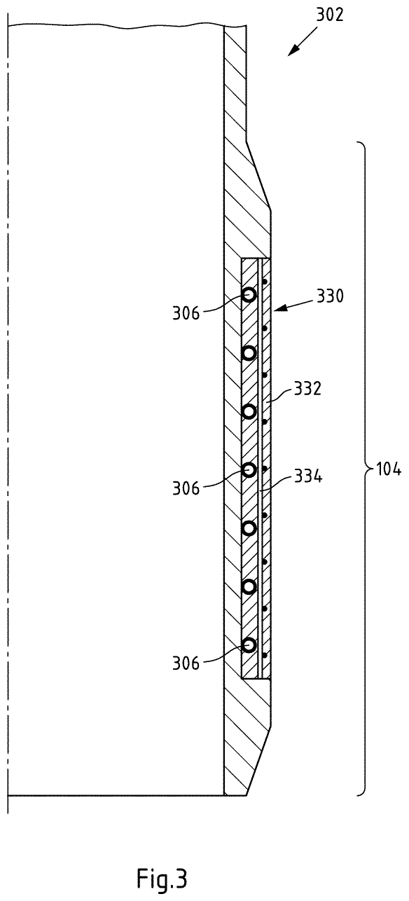

FIG. 3 shows a schematic view, in particular a section, of a further embodiment of a foundation profile 300 according to the present application. In order to avoid repetitions, essentially only the differences from the previous embodiments are explained below, and otherwise reference is made to the previous explanations.

In this embodiment, the at least one elongated hollow body 306 is at least partially embedded and integrated, respectively, in the outer wall of the profile end portion 304. As can be seen, the foundation profile 300 comprises a profile base body 336 having at least one outwardly directed (circumferential) recess 330. The profile end section 304 further comprises at least one outer wall element 332 inserted in the recess 330.

The outer wall element 332 may be at least partially formed of a concrete-containing material and/or a mortar-containing material. In particular, the at least one elongated hollow body 306 may be integral with one or more outer wall element(s) 332 formed of mortar, grout, or a concrete cylindrical shell. Preferably, the outer wall element 332 may include a reinforcement 334. In particular, the outer wall element 332 may act similar to a “white tank”.

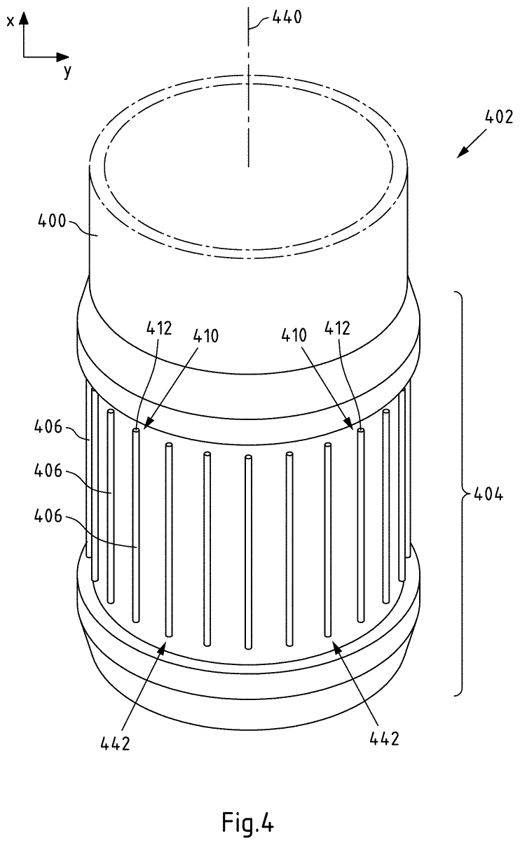

FIG. 4 shows a schematic view, in particular a section, of a further embodiment of a foundation profile 400 according to the present application. In order to avoid repetitions, essentially only the differences from the previous embodiments are explained below, and otherwise reference is made to the previous embodiments.

As can be seen, a plurality of elongated hollow bodies 406 are provided extending substantially in a vertical direction x. In particular, the elongated hollow bodies 406 extend substantially parallel to each other and parallel to the longitudinal axis 440 of the foundation profile. In other variations, angular courses may also be provided.

Each elongated hollow body 406 comprises, in the present embodiment, a filling opening 412 at its upper end 410. As can be seen, all filling openings 412 are arranged at a section above (viewed in vertical direction x) the profile end section 404. The respective lower end 442 is closed and has no filling opening, respectively. A filling of the hollow bodies 406 with a swellable material is possible in a simple manner.

In such an embodiment, a (not shown) distribution hose may be provided. The distribution hose may comprise a filling opening and a plurality of outlet openings, for example corresponding to the number of filling openings 412 of the elongated hollow bodies 406. The outlet openings may be fluidly coupled to respective fill openings 412 of the elongated hollow bodies 406. It shall be understood that a plurality of distribution hoses may be provided instead of one distribution hose.

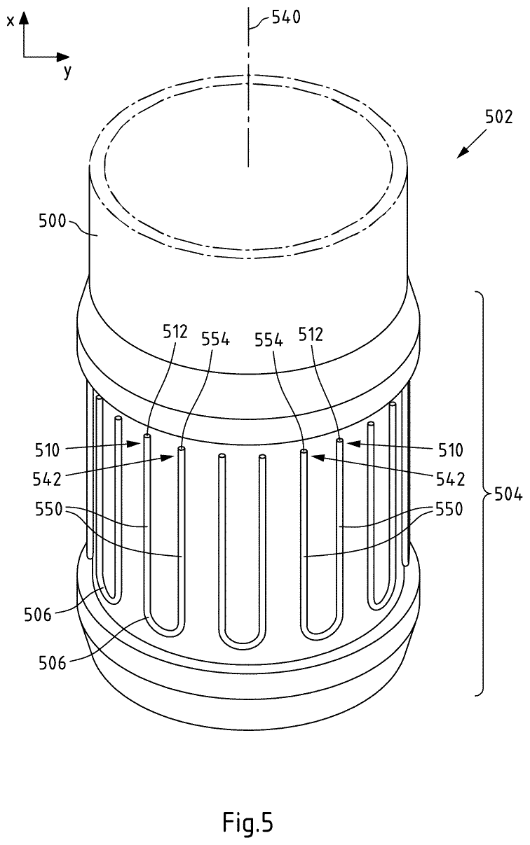

FIG. 5 shows a schematic view, in particular a section, of a further embodiment of a foundation profile 500 according to the present application. In order to avoid repetitions, essentially only the differences from the previous embodiments are explained below, and otherwise reference is made to the previous explanations.

As can be seen, a plurality of elongated hollow bodies 506 are provided, each comprising a substantially U-shaped configuration. In particular, the respective legs 550 of the elongated hollow bodies 506 extend substantially parallel to each other and parallel to the longitudinal axis 540 of the foundation profile. In other variants of the application, a V or W (or WW . . . ) arrangement may also be provided.

In the present embodiment each elongated hollow body 506 comprises a filling opening 512, 554 at both ends 510, 542. As can be seen, all filling openings 512, 554 are arranged at a section above (as seen in the vertical direction) the profile end section 504. Filling the hollow bodies 506 with a swellable material is possible in a simple manner.

In such an embodiment, a (not shown) distribution hose may be provided. The distribution hose may comprise a filling opening and a plurality of outlet openings, for example corresponding to the number of filling openings 512, 554 of the elongated hollow bodies 506. The outlet openings may be fluidly coupled to respective fill openings 512, 554 of the elongated hollow bodies 506. It shall be understood that a plurality of distribution tubes may be provided instead of one distribution tube.

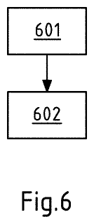

FIG. 6 shows a diagram of an embodiment of a method according to the present application, in particular for installing a foundation profile, such as a foundation profile according to any of FIGS. 1 to 5.

In step 601, a filling of at least one swellable material into the at least one elongated hollow body takes place. Preferably, a mixture (prepared immediately before or with a specific time delay) of a swellable material and at least one further material causing the expansion of the swellable material (preferably water) with a specific mixing ratio can be filled in, in particular, injected (under pressure).

In a step 602, an inserting of the profile end portion of the foundation profile into an offshore subsoil is performed.

The step 601 may be performed temporally at least partially before the step 602, at least partially during the step 602 and/or at least partially after the step 602.

In a preferred variant of the method according to the application, the profile end section of the foundation profile is first introduced into an offshore subsoil, preferably by vibrating it in. In other variants, ramming can also take place or a borehole can first be generated into which the profile end section of the foundation profile can then be inserted.

Subsequently, for example by means of an injection device that can be fluidly coupled to the at least one filling opening, a swellable material, preferably the mixture described above, can be filled into the at least one elongated hollow body, in particular using pressure.

In a preferred embodiment, a hollow body may be filled with an intermediate fluid in the form of a liquid. Before filling with the swellable material, in particular, the mixture described above, this intermediate fluid, in particular water, can be drained.

By the optional perforation holes in the elongated hollow body, in particular the groundwater present at the offshore subsoil can penetrate and react with the swellable material. It shall be understood that perforation may be omitted in the mixture described above.

In particular, in the method according to the application, the expansion can be controlled in terms of time. Due to the increased bracing at the contact surface between the foundation profile and the offshore subsoil, the skin friction is increased, so that the load-bearing capacity can in turn be increased.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A foundation profile for an offshore structure, comprising:
a profile end section arranged in an offshore subsoil in the intended state of the foundation profile; and
at least one elongated hollow body arranged at the profile end portion in the intended state and configured to receive a swellable material,
wherein the elongated hollow body is externally laid to an outer wall of the profile end section.

2. The foundation profile of claim 1, wherein
the elongated hollow body is a perforated elongated hollow body.

3. The foundation profile of claim 1, wherein
the elongated hollow body is arranged in a spiral shape at the profile end section, preferably in a double-spiral shape.

4. The foundation profile of claim 1, wherein
the swelling material is selected from the group comprising:
cement-based material,
CaO-based material,
al powder-based material.
alkali silica mixtures of materials, and
alkali carbonate mixtures of materials.

5. The foundation profile of claim 1, wherein
the elongated hollow body comprises a sheathing made of a flexible material,
wherein the material of the elongated hollow body has a modulus of elasticity of at most 10 GPa at 20° C., in particular between 0.01 and 5 GPa at 20° C.

6. The foundation profile of claim 1, wherein
the elongated hollow body has a diameter in a normal state between 2 and 10 cm, and in an expanded state, the diameter is increased between 0.5 and 5%.

7. The foundation profile of claim 1, wherein
the profile end section comprises at least one profile base body with at least one outwardly directed recess, and
the profile end section comprises at least one outer wall element inserted in the recess.

8. The foundation profile of claim 1, wherein
the elongated hollow body comprises at least one filling opening, configured to fill the swellable material into the elongated hollow body,
wherein the filling opening is arranged at least above the offshore subsoil surface in the intended condition.

9. A foundation set, comprising:
at least one foundation profile comprising at least one section end portion arranged in an offshore subsoil in the intended state of the foundation profile; and
at least one elongated hollow body arrangeable at an outer wall of the profile end portion in the intended state and configured to receive a swellable material.

10. An offshore structure, in particular an offshore wind energy structure, comprising at least one foundation profile of claim 1.

11. A method of installing the foundation profile of claim 1, comprising:
filling at least one swellable material into the elongated hollow body; and
inserting the profile end portion of the foundation profile into an offshore subsoil.

12. The method of claim 11, wherein
the filling at least of the swellable material is performed during and/or after the inserting of the profile end section of the foundation profile.

13. The method of claim 11, wherein
the filling at least of the swellable material is performed prior to the inserting of the profile end section of the foundation profile.

14. The method of claim 11, wherein
filling the swellable material comprises filling a mixture from the swellable material and at least one further material causing expansion of the swellable material.

15. The method of claim 1, wherein
an at least partial filling of the elongated hollow body with an intermediate fluid is performed,
wherein the intermediate fluid is drained from the elongated hollow body prior to filling the swellable material.
